(19) United States
(12) Patent Application Publication
(10) Pub. No.: US 2013/0318079 A1
(43) Pub. Date: Nov. 28, 2013

(54) Relevance Analysis of Electronic Calendar Items

(71) Applicant: Charles Kindel, Bellevue, WA (US)

(72) Inventor: Charles Kindel, Bellevue, WA (US)

(73) Assignee: BIZLOGR, INC, Redmond, WA (US)

(21) Appl. No.: 13/479,501

(22) Filed: May 24, 2012

(51) Int. Cl. G06F 17/30

(52) U.S. Cl. CPC G06F 17/30598
USPC 707/728; 707/737

(57) ABSTRACT

A user's electronic calendar may be analyzed to identify those calendar items that relate to a specific topic or classification. The classification may identify, for example, business or personal items, or items relating to a specific project, task, or other classification. The analysis may classify calendar items by a set of heuristics as well as by associations between calendar items and with other databases. The associations may include analysis of a user's contact list, social networks, and other information.

### BACKGROUND

Calendar systems maintain a user's appointments, meetings, and other dates. Many electronic calendar systems store appointments and remind the user when the appointment draws near. Some calendared events may include other users, such as meetings where the calendar system may send invites to the users and track their responses.

### SUMMARY

A user's electronic calendar may be analyzed to identify those calendar items that relate to a specific topic or classification. The classification may identify, for example, business or personal items, or items relating to a specific project, task, or other classification. The analysis may classify calendar items by a set of heuristics as well as by associations between calendar items and with other databases. The associations may include analysis of a user's contact list, social networks, and other information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system that may classify calendar items.

FIG. 2 is a diagram illustration of an embodiment showing various information sources that may be used to classify a calendar item.

FIG. 3 is a flowchart illustration of an embodiment showing a method for automatically classifying calendar items.

FIG. 4 is a flowchart illustration of an embodiment showing a method for receiving user input to assist in classifying calendar items.

### DETAILED DESCRIPTION

A calendar item may be classified by analyzing relationships between the item and other data objects. The relationships may identify the relevancy of the calendar item to a given set of classification criteria and thereby provide a weighted score for how well the calendar item matches the criteria.

The calendar items may be analyzed against many different types of databases, including contacts databases, social networks, location databases and services, project databases, document databases, as well as other calendar databases and still other sources of information. A crawler or other mechanism may traverse the databases to find one or more relationships to a calendar item. The relationships may be analyzed to determine a relevance value for that calendar item with respect to the classification criteria.

The analysis of calendar items may generate a calculated relevance value that determines how to classify a specific calendar item. The system may base the guess on the number of relationships and the strength of the relationships between the calendar item and the criteria. The calculated relevance score may be based on various heuristics, rules of thumb, or other assumptions that may be explicitly or implicitly made regarding the relationships.

In some embodiments, a user may manually update or change the relevance of certain relationships. In a typical embodiment, a computerized system may automatically attempt to classify a set of calendar items. Once the automatic analysis has completed, the user may be presented with some or all of the calendar items that are classified. The user may be able to override the computer generated results.

When a user overrides a computer generated result, the user's input may be saved for later analysis. The user's input may be used in place of a heuristic or other assumptions so that later analyses will incorporate the user's input.

Calendar items may be classified for several different use scenarios. One use scenario may classify past calendar items for various forensic uses. For example, a user may wish to classify old calendar items to identify where the user traveled for business reasons, or how much time the user spent volunteering with a certain organization.

Another use scenario may classify new or future calendar items. For example, a user may add an appointment to a calendar which may be classified by the classification system. The classification may trigger different behaviors or options for the calendar item. For example, a business related calendar item may have an audible reminder set 15 minutes ahead of time while a personal calendar item may have no audible reminder. Many other use scenarios may be enabled using the classification system for analyzing past, current, and future calendar items.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable storage medium may be any medium that may contain or store a set of instructions for execution by a processor or other instruction execution system.

The computer-usable or computer-readable storage medium may be for example, but not limited to, an electronic, magnetic, optical, electromagnetic, infrared, or semiconductor system, apparatus, or device. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

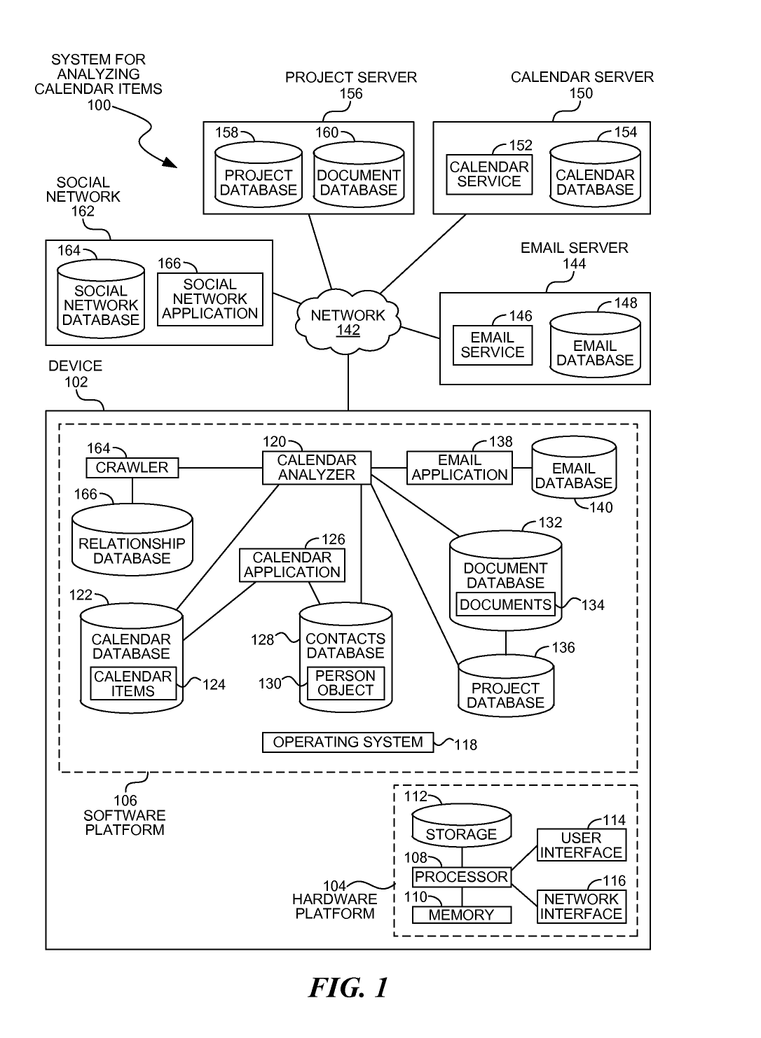

FIG. 1 is a diagram of an embodiment 100, showing a system for analyzing calendar items. Embodiment 100 is a simplified example of a network environment in which calendar items may be classified based on relationships with various other data sources.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Calendar items often describe a user's life. Many people track every day appointments, reminders, and other items in a calendar application. These calendar items can sometimes be cryptic or incompletely filled out, but their relationships to other items, such as people, locations, projects, or other calendar items may give clues to how the calendar item may be classified.

A system for classifying calendar items may analyze a set of calendar items and classify those items that meet a certain set of criteria. For example, a user may wish to find all of the calendar items that relate to a certain project, or find those calendar items that were business related as opposed to personal items.

When the calendar items are not expressly classified, such as using metadata tags or other mechanisms, a guess or estimation of the classification may be made by identifying relationships between the calendar items and other data. In a simple example, a calendar item that refers to another user may be classified based on the user's relationship with the other user. If the other user is a work contact, such as the user's boss, the calendar item may likely be a work related item.

The classification may be estimated by evaluating and classifying relationships between a calendar item and any other data source. In some cases, two or more relationships may be combined to increase or decrease the classification. Some embodiment may permit two, three, or more sequential relationships to be evaluated to determine a classification.

Some embodiments may crawl various databases to identify relationships between various items. Some such embodiments may crawl the databases on an ongoing basis and use the results during a classification analysis. In other embodiments, the crawling may happen as part of a classification analysis.

A calendar analyzer may attempt to classify a given calendar item based on a set of criteria. The criteria may identify people, locations, keywords, or other indicators that characterize a specific classification. In many cases, a set of criteria may include many different parameter values that may positively or negatively identify a match.

In some embodiments, the analyzer may assist a user in identifying a set of criteria by determining or suggesting criteria that appear to match the user's criteria. For example, a user may wish to find all work related items in a calendar database. An analyzer may attempt to determine work related criteria by identifying the company who employs the user and examine the user's contact list to determine which contacts work for the same employer. From the list of probable work related contact, a search may be performed to classify work related calendar items where coworkers are listed. In such an embodiment, the analyzer may perform one search to identify an expanded set of criteria and a second search to match those criteria to calendar items.

An analyzer may use many different types of databases to find relationships to calendar items. In addition to contacts databases mentioned above, the analyzer may use document database, project databases, social networks, email databases, or any other information source. In some instances, the databases may be private databases that contain user's personal information, such as contact databases or email databases. In other instances, the databases may be shared databases such as document or project databases. Some such databases may be shared within a company or other limited access situation, while other databases may be publically accessible. In some cases, an analyzer may search the World Wide Web to find a relationship.

Private databases may be searched after providing authentication or credentials to access the databases. In some cases, the analyzer, crawler, or other automated access system may present credentials in order to crawl or analyze the private databases.

The device 102 is illustrated having hardware components 104 and software components 106. The device 102 as illustrated represents a conventional computing device, although other embodiments may have different configurations, architectures, or components.

In many embodiments, the device 102 may be a personal computer. In some embodiments, the device 102 may still also be a server computer, desktop computer, laptop computer, netbook computer, tablet or slate computer, wireless handset, cellular telephone, game console or any other type of computing device.

The hardware components 104 may include a processor 108, random access memory 110, and nonvolatile storage 112. The hardware components 104 may also include a user interface 114 and network interface 116.

The processor 108 may be made up of several processors or processor cores in some embodiments. The processors may be general purpose processor, a digital signal processor (DSP), an application specific integrated circuit (ASIC), a field programmable gate array (FPGA) or other programmable logic device, discrete gate or transistor logic, discrete hardware components, or any combination that may perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The software components 106 may be embodied directly in hardware, in a software module executed by a processor, or in a combination of the two. When embodied in hardware, the software components 106 may be implemented as gate arrays or other programmable logic device, discrete grate or transistor logic, discrete hardware components, or other hardware mechanism. When embodied in software, the instructions that comprise the various software components 106 may be loaded into memory and executed by a processor to perform various tasks.

Embodiment 100 illustrates an embodiment where a user's device 102 may perform the role of calendar analyzer. Other embodiments may have a calendar analyzer function performed by a remote server, which may be located in a local area network, in a wide area network such as the Internet, or as a cloud based analysis tool accessed over a network connection.

The device 102 may contain a calendar analyzer 120 which may analyze a calendar database 122 that contains various calendar items 124. The calendar items 124 may be appointments, reminders, or any other database item that contains a date and time designation. In many cases, a calendar item may contain a location item, subject description, attendees, reminder flags, time zone indicators, recurrence information, categorization identifiers, importance designators, notes, time zone designators, privacy identifiers, attachments, hyperlinks, or any other information or identifier. In many cases, calendar items may have additional metadata, including owner, created by, created time, forwarded by, sent to, or other information.

A user may normally access the calendar items 124 using a calendar application 126. In many embodiments, a calendar database 122 may be shared across multiple devices, such as a desktop computer, a cellular telephone, and a tablet computer, where each device may have a different calendar application 126 to access, update, and edit calendar items 124.

A contacts database 128 may include various person objects 130. The person objects may store various data about people and other items that may be tracked or associated with calendar items, email, or other objects. The person objects 130 may include various parameters that describe or relate to a person, such as their first name, last name, middle name, prefix, suffix, job title, company, business address, home address, various phone numbers, instant messaging handle, social network names, email addresses, spouse, birthday, anniversary, internet addresses, job related items such as department, manager's name, or assistant's name, or a host of other parameters.

The person objects 130 may be stored in the contacts database 128 and accessed using the calendar application 126. In some embodiments, two or more databases may contain person objects. For example, some embodiments may consolidate person objects from a local and remote database. The remote database may be a company-wide contacts database, a social network database, or other source. In such embodiments, the calendar application 126, calendar analyzer 120, or other application that accesses the contacts database 128 may view a consolidated or aggregated database of person objects that may have been collected from several databases.

A document database 132 containing documents 134 may be a source of information for classifying a calendar item. The document database 132 may be a file system, storage system, or any other repository or collection of documents 134. The documents 134 may be any type of electronic file, object, or other item.

A project database 136 may be linked to the document database 132. The project database 136 may include scheduling items, project activities and tasks, and other items that are related to various projects.

Within the document database 132 and project database 136, various items may have information that may be used to classify calendar items. For example, many documents or project items may include content such as text, graphics, date and time information, or other information. In many cases, documents or project items may include metadata, such as time the item was created, who created the item, classification information for the item, and other metadata.

A calendar classification system may find relationships between documents or project related items in order to classify a calendar item. For example, a calendar item may include a description that may be mapped to a project name. The relationship between a project document and the calendar item may allow a classification system to infer that the calendar item may be related to the project.

Document metadata may also be used to classify a calendar item. For example, a document that was created by a user at the same time as an appointment in the user's calendar may infer that the appointment was related to the document. The document's relationship to a specific project may infer that the appointment may be related to the project.

An email application 138 may provide access to an email database 140 that may contain email and other item. Similar to analyzing documents, contacts, and other objects, a calendar classification system may analyze email items to identify relationships to calendar items. The email contents and metadata may be used to identify and classify relationships to calendar items. In some cases, date and time relationships between calendar items and email items may establish relationships. In other cases, email content and metadata may be analyzed to identify relationships to calendar items.

In many embodiments, a calendar analyzer 120 may access data from remote sources. The remote sources may be servers within a local or wide area network, such as within a company's corporate network. In some cases, the remote sources may be cloud based services that operate over a network. In such cases, the device 102 may communicate with the remote sources over a network 142.

A calendar analyzer 120 may access both local and remote sources in some cases. Some such embodiments may aggregate or combine items from local and remote sources together as part of an analysis.

An email server 144 may provide an email service 146 which may access an email database 148. Similarly, a calendar server 150 may provide a calendar service 152 that may access a calendar database 154. A project server 156 may include both a project database 158 and a document database 160. Other remote services may provide additional data that may be accessed by a calendar analyzer 120.

Some embodiments may access a social network 162, which may have a social network database 164 that may be accessed through a social network application 166. The social network may contain information relating to people, including similar information that may be contained in a contacts database 128. Some social networks may also provide mechanisms for users to share information, which may be in the form of posts, weblog entries, tagging or marking items, or other interactions. In many cases, the actions of users in a social network may be tagged with a date and time.

A calendar analyzer 120 may use various data from a social network to identify relationships or similarities to calendar items. The relationships may be in the form of date and time relationships. For example, a calendar item that corresponds with the same time an item is posted on a social network site may be related. In another example, a user may post an announcement about a meeting on a social network site which may correspond with a calendar item.

A social network may identify relationships between people that can assist in classifying calendar items. For example, an attendee of a meeting in a calendar item may be found in a social network and determined to be a coworker for a user. In another example, a location for a calendar item may be found to correspond with a social network contact's place of business. In both cases, a calendar analyzer may assess the relationships and may determine a classification based on the relationships found in a social network.

A crawler 164 and a relationship database 166 may be used in some embodiments. The crawler 164 may analyze the various databases to identify potential relationships and store those relationships in the relationship database 166. The crawler 164 may operate as a background process and collect relationship information on an ongoing basis. When the calendar analyzer 120 performs an analysis, the calendar analyzer 120 may analyze the relationship database 166 to identify relationships.

In another embodiment, the crawler 164 may perform a search across multiple databases at the time a calendar analyzer 120 requests information. In such an embodiment, the crawling may be performed in real time.

The relationship database 166 may store user defined or user analyzed relationships, where user input may be stored for future analyses. For example, a user may manually identify a relationship to a specific person, place, time, document, or other item as being a specific classification. When the user defines the relationship manually, that definition may override an automatically generated classification. In some embodiments, a user may be asked to manually assist in classifying certain relationships or classifications. As that input is captured, it may be reused in future analyses to give a higher confidence level to the results.

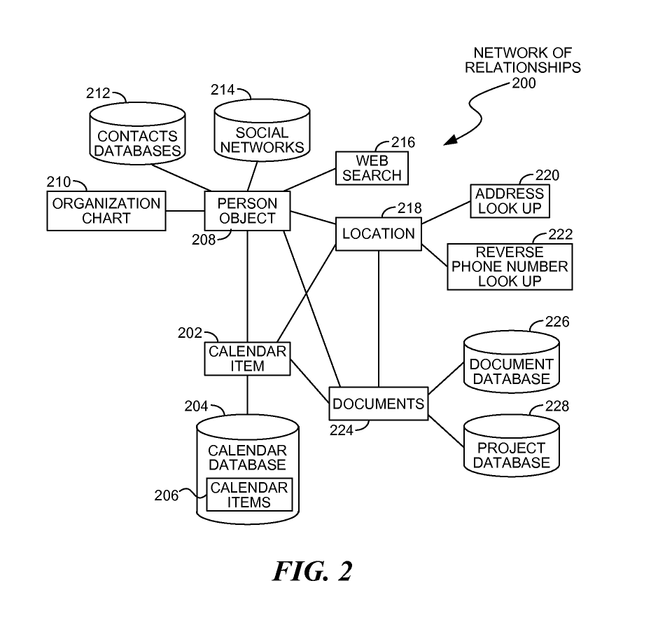

FIG. 2 is a diagram illustration of an embodiment 200 showing various data sources and illustrating examples of how relationships between data sources may be used to classify calendar items. Embodiment 200 is an example embodiment that merely shows the concepts of relationships. Other embodiments may have additional or fewer data sources and may use the data sources in different manners than as discussed in the following examples.

Embodiment 200 illustrates various data types and data sources. One, two, or more of these sources may be combined to identify relationships between a calendar item and another data item, then the relationship may be analyzed to determine a correlation for classification.

A calendar item 202 may be analyzed to classify the calendar item. The classification may have a set of criteria that, when matched, indicate a positive or negative relationship for a particular calendar item. A positive relationship may indicate that the criteria indicate a match. A negative relationship may indicate that the criteria indicate no match.

In an example of matching criteria, calendar items that are “work related” may be items that relate to people who are related to work, documents related to work, schedules that are related to work, or other items. As part of defining the criteria, a search of the various databases may be made to determine what items may be work related. For example, a user's employer may be searched within an organization chart 210, contacts database 212, social network 214, or other source to identify person objects 208 that are work related.

Using the work related person objects, an analysis may examine documents 224 that may be related to those work related person objects. The documents 224 may be extracted from a document database 226 or project database 228. From the work related documents, a set of keywords, metadata, or other items may be culled.

The matching criteria in the example may then be composed of person objects, keywords, metadata, and other “work related” items.

In the example, a calendar analyzer may attempt to find relationships between a calendar item 202 and the various parameters in the matching criteria. In the example, a relationship between a subject line in a calendar item and a keyword from a work related document may indicate that the calendar item is work related.

In the example above, an expanded set of criteria may be identified through an initial search or crawl of the databases, then the set of criteria may be applied to analyze a calendar item.

In another example, a set of criteria may be “personal”. In this example, a calendar item may be analyzed to parse any information available. The information gleaned from the calendar item may then be searched across various databases to identify relationships. For example, a calendar item may have a date, time, location, and subject information, as well as various metadata defining when the item was created and by whom. A calendar analyzer may search for other events having the same date, time, and location.

In an example when the calendar item is an item in the past, the search may attempt to find any item that has a similar date and time metadata. If the search uncovers a document saved by the user at that time, the calendar analyzer may attempt to correlate the document with the criteria.

In an example when the calendar item may be in the future, the search may attempt to find any future event that correlates with the calendar item, then determine if the future item correlates with the criteria.

In another example of a future calendar item, the search may attempt to find information about the location defined in the calendar. The search may use an Internet search engine to find a person's address corresponding to the location. Using the person's name, the search may continue to various databases that contain information on people to uncover that the listed person is a member of the same religious organization as the user. Based on that relationship, the calendar analyzer may determine that the relationship meets the criteria of “personal” and therefore apply the classification to the calendar item.

Embodiment 200 illustrates various locations where a search may be performed. Depending on the embodiment, a search may traverse from one data source to another to establish a connection from the calendar item to another item using various mechanisms. In some cases, the connection from the calendar item to another item that can be evaluated using the criteria may be multiple sequential relationships.

The calendar item 202 may be compared to calendar items 206 in a calendar database 204. In some cases, the proximity of one calendar item to another may indicate that there is a relationship between the calendar items. When a relationship is identified, the classification of one calendar item may be assumed to be similar to another.

For example, similar appointments that frequently occur in a person's calendar may indicate that the appointments may be related. In another example, two meetings that are scheduled back-to-back may indicate that the meetings take place at the same location or may have some other similarity. In still another example, two meetings that have a common attendee may be related to each other.

One or more person objects 208 may be related to a calendar item 202. The person objects 208 may be taken from any source, including organization charts 210, contacts databases 212, social networks 214, a web search 216, or any other source.

Similarly, location items 218 may be identified from address lookup services 220, or when the location may be a telephone number, through a reverse phone number lookup service 222. From the location information, a search may attempt to locate person objects 208 associated with the location, or vice versa, where a person object 208 may be identified first, then a location item 218 located based on the person object 208.

Documents 224 may be identified from the calendar item 202, person objects 208, location items 218, or from other information gathered during a search. Similarly, documents 224 may be identified directly from the calendar item 202, then used to identify other person objects 208, location items 218, or calendar items 206. The documents 224 may be searched from various document databases 226 or project database 228.

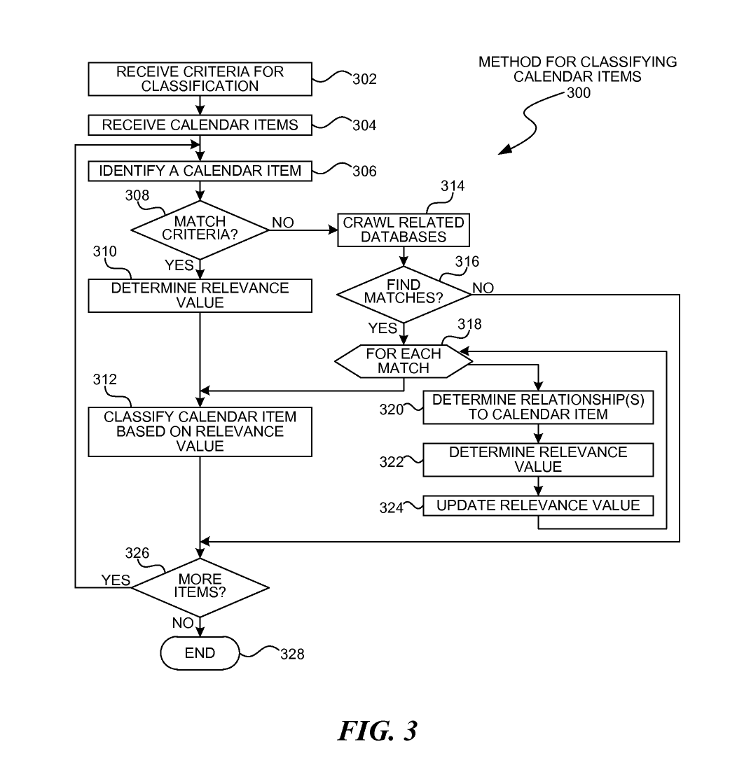

FIG. 3 is a flowchart illustration of an embodiment 300 showing a method for classifying calendar items. The process of embodiment 300 is a simplified example of one method through which calendar items may be matched to other objects, then classified based on a set of criteria.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form. In other embodiments, the steps may be represented in the form of a state diagram or other representation.

Embodiment 300 illustrates one method for classifying a calendar item based on a set of criteria. Once the criteria are defined, calendar items may be evaluated to see how well the calendar items match the criteria. When there is not a direct match, various databases may be crawled to identify possible matches, and the relationships between the matched item and the calendar item may be evaluated to determine a confidence or relevance value.

Criteria for classifying calendar items may be received in block 302. In some embodiments, the criteria may be a complex set of parameters and values that define different aspects of a classification. In other embodiments, the criteria may be a single parameter value.

In some embodiments, a set of search criteria may be analyzed and expanded into a larger set of parameters and values, including value ranges. Such an analysis may be an automated analysis of a user's databases or other sources of data.

The calendar items to be analyzed may be received in block 304 and a first calendar item identified in block 306.

The analysis may begin at block 308 where the calendar item may be compared to the search criteria. If a match exists in block 308, the relevance value of the match may be determined in block 310 and the item may be classified based on the relevance value in block 312.

The relevance value of the match in block 310 may be made using heuristics or other analysis criteria. The analysis criteria may be a set of rules, algorithms, or other mechanisms that may assign a relevance value for the direct relationship between the criteria and the calendar item.

If the calendar item is not a direct match in block 308, related databases may be crawled in block 314 to identify matches. The matches may be items in the related databases that correspond with the criteria and also have a relationship to the calendar item. If no matches are found in the related databases in block 316, the process may proceed to block 326, where another calendar item may be evaluated.

For each match in block 318, a relationship to the calendar item may be identified in block 320. Based on the relationship, a relevance value may be determined in block 322. The relevance value for the calendar item may be updated in block 324 as multiple relationships are evaluated.

The search performed in block 314 may attempt to find matches that have some relationship to the calendar item. In some embodiments, the search in block 314 may attempt to find items in the related databases that match the criteria, then determine in block 320 if a relationship to the calendar item exists.

The relevance value determined in block 322 may be determined from a set of heuristics, algorithms, or other mechanisms. The heuristics or other mechanisms may express a value or probability that a match is legitimate. In many cases, the heuristics may identify a possible match, and when multiple relationships exist, the probability of a match may increase.

Once the matches have been evaluated in block 318, the classification may be made based on the relevance value in block 312. The classification may be made based on a threshold of a relevance value. For example, a relevance value may have a range from 0 to 100, where 100 is a high confidence of a match, and 0 is a high confidence of no match. An example embodiment may classify a calendar item as a match when the relevance value is greater than 75. Those items with less than 75 relevance value may not be considered a match. In another example embodiment, the threshold may be set to 45 or even lower. Such an embodiment may have a lower threshold for determining a match.

After classifying the calendar item in block 312, if additional calendar items are to be evaluated in block 326, the process may return to block 306 to select another calendar item. Otherwise, the process may end in block 328.

In many embodiments, the original calendar item may be updated with the classification determined by the automated process of embodiment 300.

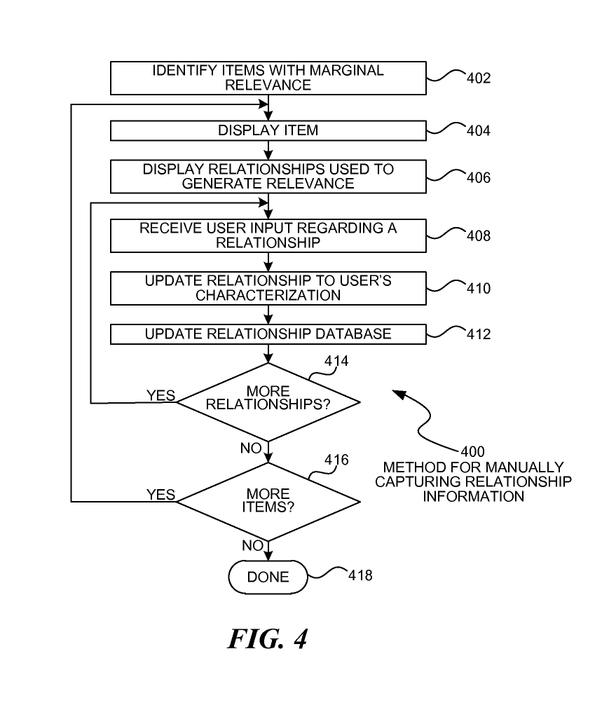

FIG. 4 is a flowchart illustration of an embodiment 400 showing a method for manually classifying calendar items. The process of embodiment 400 is a simplified example of one method by which user input may be captured to identify classification information.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one sequence whereby calendar items or relationships may be manually classified. Embodiment 400 may be used after a classification analysis has been performed. Items that have marginal or questionable classifications may be presented to a user, and the user may manually determine if there is a match or not. This information may be captured and stored in a relationship database so that future analyses may use the same information.

In block 402, items with marginal relevance may be identified. Each embodiment may define which items have marginal relevance in different manners. One method may be to identify items that are close to a threshold used to classify items based on their relevance value.

The items may be displayed in block 404 and relationships used to generate a relevance value may be displayed in block 406.

The user may view the relationships and may enter a manual value regarding the relationship in block 408. The relationship may be updated to the user's characterization in block 410, which may cause the classification of the calendar item to be changed.

The relationship database may be updated in block 412. In many embodiments, the user's classification of a relationship may supersede or override any heuristic, algorithm, or other automated manner in which the original relevance value may be defined.

If more relationships exist in block 414, the process may return to block 408. If no more relationships exist but more items exist to be analyzed in block 416, the process may return to block 404 to display the next calendar item. Once all the calendar items are analyzed in block 416, the process may end in block 418.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a plurality of calendar items, said calendar items being electronic data objects having a plurality of parameters, said parameters comprising a date and time designation and a location designation;
receiving a classification defining at least one parameter value;
analyzing said plurality of calendar items by an analysis method comprising:
finding a first calendar item having said at least one parameter value;
identifying a second object having a first relationship to said first calendar item;
determining a first relevance value based on said first relationship; and
assigning a relevance value to said second object based on said first relevance value.

2. The method of claim 1, said analysis method further comprising:
identifying a second relationship between said second calendar item and said first calendar item;
determining a second relevance value based on said second relationship; and
updating said relevance value for said second calendar item based on said second relevance value.

3. The method of claim 1, said second object being a document.

4. The method of claim 3, said analysis method further comprising:
searching a database for a term found in said first calendar item to identify said document.

5. The method of claim 4, said document being related to a project.

6. The method of claim 1, said second object being a person object.

7. The method of claim 6, said analysis method further comprising:
searching a contacts database for said person object.

8. The method of claim 7, said contacts database being a social network.

9. The method of claim 7, said person object having an associated location.

10. The method of claim 1, said second object being a location object.

11. The method of claim 10, said location object being determined from a reverse lookup of a phone number, said phone number being associated with said first calendar item.

12. The method of claim 1, said first relationship comprising a plurality of sequential relationships.

13. The method of claim 1, said first relationship being a common location between said first calendar item and said second calendar item.

14. The method of claim 1, said first relationship being a common attendee between said first calendar item and said second calendar item.

15. The method of claim 1, said first relationship being an adjacency in time between said first calendar item and said second calendar item.

16. The method of claim 1, said first relationship being an adjacency in location between said first calendar item and said second calendar item.

17. The method of claim 16, said adjacency in location being determined by determining a first location for said first calendar item and a second location for said second calendar item and determining a physical distance between said first location and said second location.

18. The method of claim 1, said first relationship being a relationship between an attendee and a user associated with said first calendar item.

19. The method of claim 18, said first relationship being determined by analyzing a list of contacts associated with said first user.

20. The method of claim 18 further comprising:
searching for a person to person relationship between said attendee and said user;
analyzing said person to person relationship to determine a nature of said person to person relationship; and
determining a relevance value based on said person to person relationship.
